(19) United States
(12) Patent Application Publication
(10) Pub. No.: US 2006/0261530 A1
(43) Pub. Date: Nov. 23, 2006

(54) Preloaded one-way valve accumulator

(75) Inventors: Frank Bradley Stamps, Colleyville, TX (US); Michael Reaugh Smith, Colleyville, TX (US); Taeoh Lee, Keller, TX (US)

Correspondence Address: PILLSBURY WINTHROP SHAW PITTMAN, LLP, P.O. BOX 10500, MCLEAN, VA, 22102, US

(73) Assignee: Bell Helicopter Textron Inc., Hurst, TX (US)

(21) Appl. No.: 11/131,174

(22) Filed: May 18, 2005

(51) Int. Cl. F16F 9/00

(52) U.S. Cl. 267/140.11

(57) ABSTRACT

A vibration isolator for connecting a first body and a second body. The vibration isolator includes a housing having a first chamber, a second chamber, and a port connecting the first chamber to the second chamber and permitting fluid to flow between the first chamber and the second chamber. The first and second chambers and the port defining a fluid reservoir. The isolator including a gas-to-fluid accumulator in fluid communication with the fluid reservoir through a first one-way valve and a second one-way valve. The first one-way valve allows fluid to pass only from the fluid reservoir to the accumulator and the second one-way valve allows fluid to pass only from the accumulator to the fluid reservoir. At least one of the first and second one-way valves being preloaded to a predetermined force to permit fluid flow through the at least one-way valve only when fluid pressure exceeds the predetermined force.

### FIELD OF THE INVENTION

The present invention relates to improvements in isolation devices. In particular, the illustrated embodiments relate to improvements in isolation devices to remove the adverse effects of accumulators.

### BACKGROUND

U.S. Pat. No. 4,236,697 to Halwes et al.; U.S. Pat. No. 6,217,011 to Redinger; and U.S. Pat. No. 6,431,530 to Stamps et al. are examples of isolators and each of which is incorporated herein by reference thereto in its entirety, respectively.

### SUMMARY OF THE INVENTION

One aspect of the subject invention includes a vibration isolator for connecting a first body and a second body, comprising: a housing having a first chamber, a second chamber, and a port connecting the first chamber to the second chamber and permitting fluid to flow between the first chamber and the second chamber, and the first and second chambers and the port defining a fluid reservoir; a gas-to-fluid accumulator in fluid communication with the fluid reservoir through a first one-way valve and a second one-way valve, the first one-way valve allowing fluid to pass only from the fluid reservoir to the accumulator and the second one-way valve allowing fluid to pass only from the accumulator to the fluid reservoir, at least one of the first and second one-way valves being preloaded to a predetermined force to permit fluid flow through the at least one-way valve only when fluid pressure exceeds the predetermined force.

Another aspect of the subject invention includes, a vibration isolator for connecting a first body and a second body, comprising: a housing having an inner surface defining a fluid volume; a tuning fluid disposed in the fluid volume; an inner cylinder disposed in the fluid volume and having a surface disposed to substantially segregate a portion of the fluid volume, the segregated portion defining a first chamber within the fluid volume; a second chamber having a variable volume; a passage connecting the first chamber to the second chamber and permitting fluid flow from the first chamber to the second chamber wherein the first and second chambers and the passage define a fluid reservoir; and a gas-to-fluid accumulator having fluid communication with the uppermost portion of the fluid reservoir, the gas-to-fluid accumulator being connected to the fluid reservoir by first and second one-way valves wherein the first one-way valve allows fluid to pass from the fluid reservoir to the accumulator and the second one-way valve allows fluid to pass from the accumulator to the fluid reservoir, and each of the first and second one-way valves being preloaded to a predetermined force to permit fluid flow through the respective one-way valve only when fluid pressure exceeds the predetermined force.

Another aspect of the present invention relates to a vibration isolator for connecting two bodies while isolating one body from vibration in the other body comprising: an outer cylinder, adapted to be connected to one of the bodies and having an elongated inner volume; an inner cylinder movably disposed within the inner volume, the inner cylinder and the inner volume defining first and second chambers at either end of the inner cylinder; a tuning port connecting the first and second chambers wherein the first and second chambers and the tuning port define a fluid reservoir; a spring connecting the inner cylinder to the outer cylinder; a tuning mass substantially filling the first and second chambers and the tuning port; and a gas-to-fluid accumulator connected to the uppermost portion of the fluid reservoir by first and second one-way valves wherein the first one-way valve allows fluid to pass from the fluid reservoir to the accumulator and the second one-way valve allows fluid to pass from the accumulator to the fluid reservoir and each of the first and second one-way valves being preloaded to a predetermined force to permit fluid flow through the respective one-way valve only when fluid pressure exceeds the predetermined force.

Another aspect of the present invention relates to a vibration isolator for connecting a first body and a second body, comprising: a housing having a first chamber, a second chamber, and a port connecting the first chamber to the second chamber and permitting fluid to flow between the first chamber and the second chamber, and the first and second chambers and the port defining a fluid reservoir; and a gas-to-fluid accumulator in fluid communication with the fluid reservoir through first and second passageways, each of the first and second passageways including means for isolating the fluid in the fluid reservoir from the accumulator within the oscillatory pressure range of normal operations.

Aspects, features, and advantages of this invention will become apparent from the following detailed description when taken in conjunction with the accompanying drawings, which are a part of this disclosure and which illustrate, by way of example, the principles of this invention.

### BRIEF DESCRIPTION OF THE DRAWINGS

The accompanying drawings facilitate an understanding of the various embodiments of this invention. In such drawings:

FIG. 1 is a cross-sectional view of a vibration isolator according to one embodiment of the present invention;

FIG. 2 is a cross-sectional view of a vibration isolator according to a second embodiment of the present invention;

FIG. 3 is an enlarged view of the vibration isolator of FIG. 1;

FIG. 4 is an enlarged view of the vibration isolator of FIG. 2;

FIG. 5 is a graph showing the operating oscillatory pressure of the embodiments of the present invention being with the range of normal operations; and

FIG. 6 is a perspective view of an aircraft structure incorporating one embodiment of the present invention.

### DETAILED DESCRIPTION OF ILLUSTRATED EMBODIMENTS

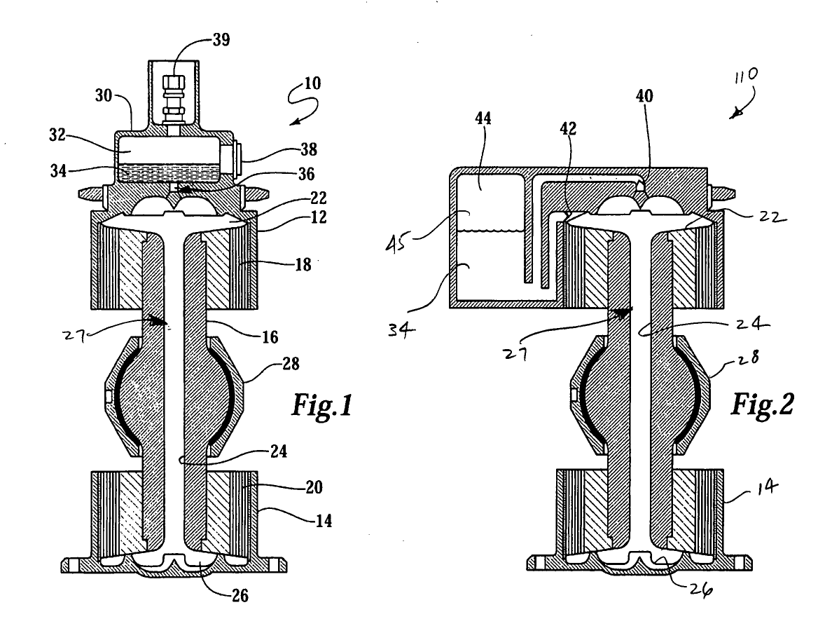

A vibration isolator according to one embodiment of the present invention is shown in FIG. 1 and generally designated 10. Vibration isolator 10 comprises an upper housing 12 and a lower outer housing 14. In this embodiment, upper housing 12 and lower housing 14 are not directly mechanically connected, but are connected indirectly via the other components of the device.

In addition to upper and lower housings 12 and 14, isolator 10 further comprises an inner cylinder 16 disposed within the volume defined by the concave portions of housings 12 and 14. In operation, inner cylinder 16 translates within this volume in reaction to motion imposed by a vibrating body.

Upper housing 12 is concentrically bonded to inner cylinder 16 by an elastomer tubeform bearing 18. Lower housing 14 is concentrically bonded to inner cylinder 16 by an elastomer tubeform bearing 20. The elastomer tubeform bearings 18 and 20 serve as compliant spring members for the isolator 10. The length of the tubeform bearings can vary according to the demands of a particular application, but the length is preferably sufficient to minimize elastomer bulging caused by oscillatory pressure in the device.

The concave inner surface of upper housing 12 and the upper surfaces of inner cylinder 16 and tubeform bearing 18 together define an upper fluid chamber 22. Upper fluid chamber 22 is connected to the lower portions of isolator 10 via a tuning port 24 passing through inner cylinder 16. The concave inner surface of lower housing 14 and the lower surfaces of inner cylinder 16 and tubeform bearing 20 together define a lower fluid chamber 26, which is in fluid communication with the lower end of tuning port 24. In addition to serving as compliant spring members for the isolator 10, elastomer tubeform bearings 18 and 20 serve as the fluid seals for fluid chambers 22 and 26.

The fluid chambers 22 and 26 and tuning port 24 are filled with an inviscid fluid 34 to form fluid reservoir 27 and pressurized to prevent cavitation. Isolator 10, as illustrated, incorporates a central elastomeric spherical bearing 28 in addition to the two elastomeric tubeform bearings 18 and 20.

In operation, the upper and lower housings 12 and 14 are mounted to the body to be isolated from vibration. The spherical bearing 28 is connected to the vibrating body. As the inner cylinder 16 moves within the isolator 10, the volume of one of chambers 22 and 26 will increase as the other decreases. This change in volume creates a pressure differential between the chambers 22 and 26 and a corresponding flow of the inviscid fluid 34 from one chamber to another, in the opposite direction of movement of the inner cylinder 16. This movement of fluid 34 within tuning port 24 causes an inertial force to be generated. Within a selected range of frequencies, this inertial force substantially or completely cancels out the elastomeric spring force in the isolator 10.

In order to stabilize internal fluid pressures, fluid and elastomer thermal expansion is accommodated through the use of an integral volume compensator 30. The volume compensator 30 alleviates the accumulation of excessive pressure and the risk of cavitation that would otherwise exist due to volume changes and associated pressure oscillations caused by operation of the isolator across a broad range of temperatures. In the isolator shown in FIG. 1, the compensator 30 takes the form of an air spring 32 filled with a gas, such as nitrogen. In this design, the compensator does not require a barrier between the gas 32 and the fluid 34. However, a compensator with a barrier between the gas 32 and the fluid 34 may be employed. Empirical data has shown that one embodiment of the present invention exhibits approximately +/−35% change in internal fluid pressure over a temperature range of −45 deg. F to +150 deg. F. Accordingly, it is desirable that the pressure within the volume compensator 30 be set to at least 35% above the vapor pressure of the tuning fluid so as to avoid cavitation. The internal pressure is bounded at the high end by the mechanical stress limits of the isolator materials. The embodiment shown in FIG. 1 incorporates a sight glass 38 for visually determining the level of fluid in the compensator and a gas valve 39 for pressurizing the gas directly. In certain embodiments of the present invention, the inner surfaces of the isolator are shaped so as to allow bubbles to rise to the compensator when the isolator is disposed in its normal orientation.

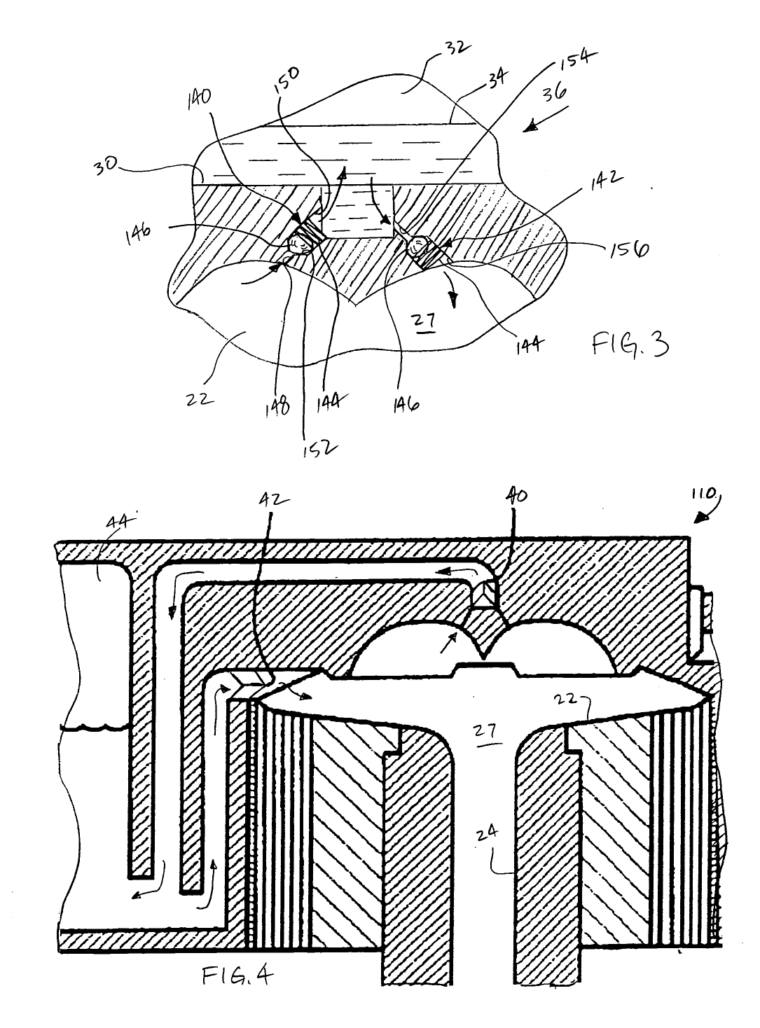

Isolator 10 communicates fluid pressure to the volume compensator 30 via preloaded valve assembly 36. As seen in FIG. 3, preloaded valve assembly 36 includes a first, preloaded one-way valve 140 and a second, preloaded one-way valve 142. In this embodiment, the first one-way valve 140 being an exit valve allows bubbles and fluid to pass from the fluid reservoir 27 to the compensator 30 once the preload pressure of the valve 140 has been overcome. Similarly, the second one-way valve 142 being an entrance valve allows fluid to pass from the compensator 30 to the fluid reservoir 27 once the preload pressure of the valve 142 has been overcome. With this design, any bubbles formed in the fluid reservoir 27 will float to the top of the fluid reservoir 22 and upon a sufficient pressure of the fluid in reservoir 27 to overcome the predetermined force applied against ball 146, they will pass through one-way valve 140 into compensator 30, where they are collected and added to the gas volume in the compensator 30. Also, during, for example, thermal expansion, fluid will pass from reservoir 27 to compensator 30 once the preload of the valve 140 has been overcome. Thus, fluid, both gas and liquid, may pass through the valve 140 upon the presence of sufficient pressure to overcome the preload of the valve 140.

Any volume lost in the form of bubbles from the fluid reservoir 27 to the compensator 30 through valve 140 is returned to the fluid reservoir 27 through one-way valve 142 in the form of liquid upon the presence of sufficient pressure to overcome the preload of the valve 142. The preload on valve 142 may be the same as that on valve 140 or different, including none at all, as desired.

The design of the preloaded one-way valves 140 and 142 may take any appropriate form that provides the ability of the valve to prohibit the passage of fluid therethrough unless the fluid has exceeded a certain, predetermined pressure. Thus, the valves 140 and 142 are preloaded to that predetermined force so that they will open only after the preload has been exceeded. The design of valves to accomplish this function may include numerous types of valve, only a few of which are described herein.

In the illustrated embodiment of FIG. 3, each one-way valve 140 and 142 takes the form of a mechanical spring 144 loaded with a ball 146. In particular, valve 140 includes a generally cylindrical inlet 148 and a generally cylindrical outlet 150, which has a larger diameter than the inlet 148. The outlet 150 includes a recessed portion 152 for receiving ball 146. The dimensions and configuration of the one-way valve 140 may take various forms as necessary for the desired performance of the isolator 10. For example, the dimensions of the inlet 148 and the force applied by spring 144 on ball 146 may be varied, as desired. In accordance with an embodiment of the invention, the force of the spring on the ball is predetermined and remains set to ensure that the valve 140 and the passage between the operating fluid in reservoir 27 and the compensator 30 remain closed over the normal operating pressure oscillations of the isolator 10. Thus, the presence of the compensator 30 does not adversely affect the overall performance of the isolator 10 and the addition of preloaded, one-way valves 140 and 142 as disclosed herein enhances performance of the isolator 10 by substantially eliminating the apparent presence of the compensator 30 within a limited pressure range.

One-way valve 142 may be formed in a substantially identical manner as set forth above with respect to one-way valve 140, except that the inlet 154 is adjacent the fluid in compensator 30 and the outlet 156 is adjacent the top of fluid reservoir 27. Upon a sufficient pressure of the fluid in compensator 30 to overcome the predetermined force applied against ball 146, the liquid 34 in compensator 30 passes through the valve 142 and into the reservoir 27. Also, although valve 142 may be configured so that the predetermined force needed for fluid to pass through valve 142 may be substantially identical to the predetermined force needed for fluid to pass through valve 140, the predetermined force for each valve 140 and 142 may be tailored for each valve independently, as desired.

Damping within isolator 10 is minimized through the use of elastomer bearings 18 and 20 having low damping characteristics and through the use of an inviscid fluid 34 within the device. Damping is additionally minimized through the use of a tuning port 24 having a relatively large value. A large diameter tuning port 24 reduces damping in the isolator 10 by minimizing the velocity of fluid 34 within the tuning port 24.

The fluid 34 used may vary from one embodiment to another, but it is desirable that the fluid 34 have a low viscosity and be noncorrosive. For example, fluid 34 of isolator 10 may be SPF I manufactured by LORD CORPORATION.RTM. Other embodiments may incorporate mercury or hydraulic fluid having dense particulate matter suspended therein. Additionally, the mass of the fluid may in some embodiments be supplemented by the use of a solid slug disposed in the tuning port 24.

Similarly, the elastomer used for the isolator tubeform bearings 18 and 20 can vary, but it is desirable that the elastomer have a long fatigue life and exhibit low damping characteristics. For example, the elastomer may be LORD SPE X.RTM. elastomer manufactured by LORD CORPORATION.RTM.

FIGS. 2 and 4 shows another embodiment of the present invention in the form of isolator 110, wherein the gas-to-fluid accumulator 44 is connected to the isolator by a first, preloaded one-way valve 40 and a second, preloaded one-way valve 42. In this embodiment, the first one-way valve 40 being an exit valve allows bubbles to pass from the fluid reservoir 27 to the accumulator 44 once the pressure in the reservoir 27 has overcome the preload on the valve 40 and the second one-way valve 42 being an entrance valve allows fluid to pass from the accumulator 44 to the fluid reservoir 27 once the pressure in the accumulator 44 has overcome the preload on the valve 42. With this design, any bubbles formed in the fluid reservoir 27 will float to the top of the fluid reservoir 22 and pass through one-way valve 40 into accumulator 44, where they are collected and added to the gas volume in the accumulator 44. Any volume lost in the form of bubbles from the fluid reservoir 27 to the accumulator 44 through valve 40 is returned to the fluid reservoir 27 through one-way valve 42 in the form of fluid.

The construction illustrated in FIG. 2 permits the accumulator to be located in any position with respect to the reservoir 27 and illustrate another of the various configurations of the preloaded one-way valves of the subject application.

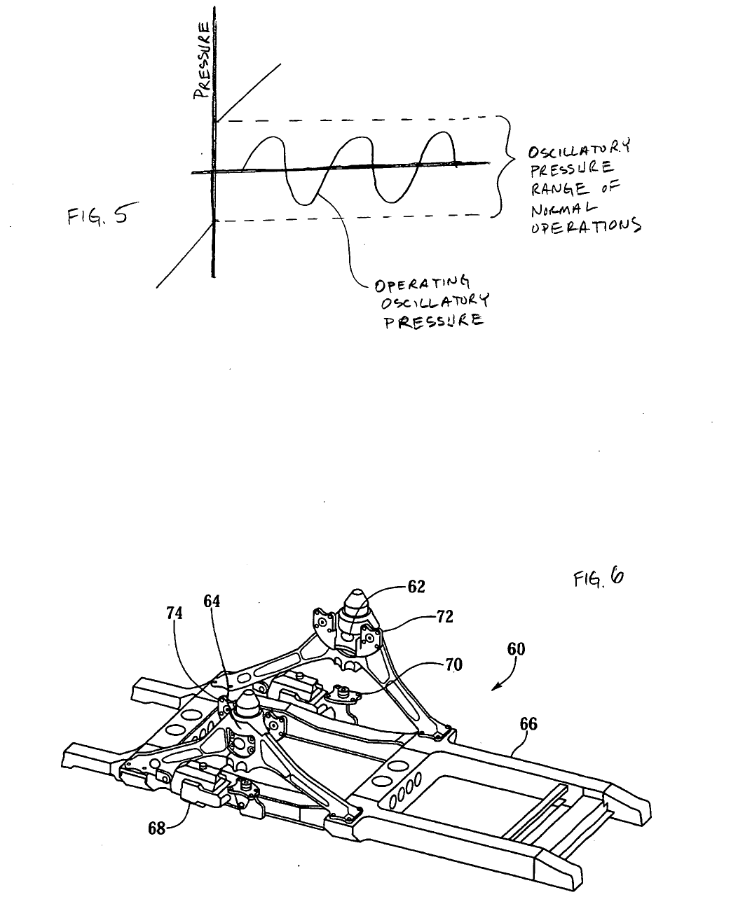

The one-way valves 40 and 42 function in a substantially identical manner as one-way valves 140 and 142 described above. However, as illustrated, one-way valves 40 and 42 are configured as preloaded flapper valves. Of course, the flapper valves 40 and 42 illustrate another embodiment for forming one-way valves and other, alternative appropriate one-way valve designs may be employed. As with the one-way valves 140 and 142 above, valves 40 and 42 are preloaded such that the accumulator 44 is isolated from the fluid in the reservoir 27 and the preloaded flapper valves are constructed so that the valves 40 and 42 remain closed over the normal operating pressure oscillations of the isolator 110. As with the valves 140 and 142 above, valves 40 and 42 permit substantially complete isolation of the accumulator 44 from the working fluid in reservoir 27 within the oscillatory pressure range of normal operation of the isolator 110. This is shown as a graph in FIG. 5 as the operating oscillating pressure of isolator 10, 110 functions with the oscillating pressure range of normal operations.

The use of preloaded, one-way valves such as 140, 142, 40 and 42 permit the use of physically smaller isolators 10, 110 since the performance (i.e., depth of isolation valley) is improved, allowing smaller tuning port 24 diameters and, thus, smaller associated overall piston areas. The resulting smaller, isolating devices are not only of lighter weight and less expensive, but they are also easier to utilize in more locations without design constraints associated with the larger-sized isolators. Further, since the use of the preloaded, one-way valves such as 40,42, 140 and 142 substantially isolates the accumulator 44 from the working fluid in reservoir 27, the accumulator 44 may be of the type with an air bubble 45, as illustrated, or can be another type of accumulator, such as a diaphragm accumulator. Further the use of the preloaded, one-way valves such as 40,42, 140 and 142 allows the accumulator 44 to be positioned below the upper most portion of the working fluid in reservoir 27. The preloaded, one-way exit valve such as 40, 140 is positioned at the upper most portion of the working fluid in reservoir 27 to scavenge bubbles from the working fluid.

One embodiment of a vibration isolator 10, 110 of the present invention as installed in a helicopter fuselage substructure is shown in FIG. 6. Helicopter fuselage substructure 60 comprises vibration isolators 62 and 64 mounted to a substructure frame 66 to work in combination with rotor pitch restraints 68 and 70. A vibrating apparatus, in this case a transmission and main rotor pylon assembly (not shown) is mounted between isolators 62 and 64 on mounting yokes 72 and 74. As described above, each of isolators 62 and 64 is compliant in the vertical axis due to the tubeform bearings 18, 20 resulting in countermotion of fluid 35 in tuning port 27 and also compliant about the two orthogonal horizontal rotational axes of pitch and roll due to the spherical bearing. For a pylon assembly mounted between isolators 62 and 64, the substructure will restrict motion in the vertical, the fore and aft, and the lateral axes, but will allow the assembly to pitch about the axis running from the spherical bearing in isolator 62 to the spherical bearing in isolator 64. Movement and vibration about this axis is restricted by pitch restraints 68 and 70.

It should be understood that the concepts disclosed herein are equally applicable to structures other than those illustrated herein in the attached figures. For example, the one-way valves disclosed above may be incorporated into vibration isolation structures such as those various isolation structures disclosed in U.S. Pat. No. 4,236,607 to Halwes et al., which has been incorporated herein by reference thereto.

While the making and using of various embodiments of the present invention are discussed in detail below, it should be appreciated that the present invention provides many applicable inventive concepts which can be embodied in a wide variety of specific contexts. The specific embodiments discussed herein are merely illustrative of specific ways to make and use the invention and do not delimit the scope of the invention.

The foregoing embodiments have been provided to illustrate the structural and functional principles of the present invention, and are not intended to be limiting. To the contrary, the present invention is intended to encompass all modifications, alterations, and substitutions within the spirit and scope of the appended claims.

What is claimed is:

1. A vibration isolator for connecting a first body and a second body, comprising:
a housing having a first chamber, a second chamber, and a port connecting said first chamber to said second chamber and permitting fluid to flow between said first chamber and said second chamber, and said first and second chambers and said port defining a fluid reservoir;
a gas-to-fluid accumulator in fluid communication with said fluid reservoir through a first one-way valve and a second one-way valve, said first one-way valve allowing fluid to pass only from said fluid reservoir to said accumulator and said second one-way valve allowing fluid to pass only from said accumulator to said fluid reservoir,
at least one of said first and second one-way valves being preloaded to a predetermined force to permit fluid flow through said at least one-way valve only when fluid pressure exceeds said predetermined force.

2. A vibration isolator according to claim 1, wherein
said fluid in said fluid reservoir includes a gas and a liquid and said first one-way valve allows both gas and liquid to pass from said fluid reservoir to said accumulator.

3. A vibration isolator according to claim 1, wherein
said accumulator is positioned on top of said fluid reservoir.

4. A vibration isolator according to claim 1, wherein
said at least one of said first and second one-way valves being preloaded to a predetermined force includes said first one-way valve being preloaded to a first predetermined force to permit fluid flow through said first one-way valve only when fluid pressure exceeds said first predetermined force and said second one-way valve being preloaded to a second predetermined force to permit fluid flow through said second one-way valve only when fluid pressure exceeds said second predetermined force.

5. A vibration isolator according to claim 4, wherein
said first predetermined force and said second predetermined force are substantially equal.

6. A vibration isolator according to claim 1, wherein
said first predetermined force is such that at least one of said one-way valves remains closed over normal operating pressure oscillations of the fluid in said fluid reservoir.

7. A vibration isolator according to claim 4, wherein
said first and second predetermined forces are such that each of said first and second one-way valves remain closed over normal operating pressure oscillations of the fluid in said fluid reservoir.

8. A vibration isolator according to claim 1, wherein
at least one of said first and second one-way valves includes a spring-loaded ball.

9. A vibration isolator according to claim 1, wherein
said first and second one-way valves include a spring-loaded ball.

10. A vibration isolator according to claim 1, wherein
at least one of said first and second one-way valves includes a flapper valve.

11. A vibration isolator according to claim 1, wherein
said first and second one-way valves include a flapper valve.

12. A vibration isolator for connecting a first body and a second body, comprising:
a housing having an inner surface defining a fluid volume;
a tuning fluid disposed in the fluid volume;
an inner cylinder disposed in the fluid volume and having a surface disposed to substantially segregate a portion of the fluid volume, the segregated portion defining a first chamber within the fluid volume;
a second chamber having a variable volume;
a passage connecting the first chamber to the second chamber and permitting fluid flow from the first chamber to the second chamber wherein the first and second chambers and the passage define a fluid reservoir; and
a gas-to-fluid accumulator having fluid communication with the uppermost portion of the fluid reservoir,
the gas-to-fluid accumulator being connected to the fluid reservoir by first and second one-way valves wherein the first one-way valve allows fluid to pass from the fluid reservoir to the accumulator and the second one-way valve allows fluid to pass from the accumulator to the fluid reservoir, and each of the first and second one-way valves being preloaded to a predetermined force to permit fluid flow through said respective one-way valve only when fluid pressure exceeds said predetermined force.

13. A vibration isolator according to claim 12, wherein
said predetermined force is such that each of said first and second one-way valves remain closed over normal operating pressure oscillations of the fluid in said fluid reservoir to isolate the fluid in said fluid reservoir from said accumulator within the oscillatory pressure range of normal operations.

14. A vibration isolator according to claim 12, further comprising:
a spherical bearing adapted to connect the vibration isolator to the first body.

15. A vibration isolator according to claim 12, wherein
the inner surfaces of the isolator are shaped so as to allow gas bubbles to rise to the top of the isolator when the isolator is disposed in its normal orientation.

16. A vibration isolator for connecting two bodies while isolating one body from vibration in the other body comprising:
an outer cylinder, adapted to be connected to one of the bodies and having an elongated inner volume;
an inner cylinder movably disposed within the inner volume, the inner cylinder and the inner volume defining first and second chambers at either end of the inner cylinder;
a tuning port connecting the first and second chambers wherein the first and second chambers and the tuning port define a fluid reservoir;
a spring connecting the inner cylinder to the outer cylinder;
a tuning mass substantially filling the first and second chambers and the tuning port; and
a gas-to-fluid accumulator connected to the uppermost portion of the fluid reservoir by first and second one-way valves wherein the first one-way valve allows fluid to pass from the fluid reservoir to the accumulator and the second one-way valve allows fluid to pass from the accumulator to the fluid reservoir and each of the first and second one-way valves being preloaded to a predetermined force to permit fluid flow through said respective one-way valve only when fluid pressure exceeds said predetermined force.

17. A vibration isolator according to claim 16, wherein
said predetermined force is such that each of said first and second one-way valves remain closed over normal operating pressure oscillations of the fluid in said fluid reservoir to isolate the fluid in said fluid reservoir from said accumulator within the oscillatory pressure range of normal operations.

18. A vibration isolator according to claim 16, further comprising:
a spherical bearing mounted to the inner cylinder and adapted to be connected to a second body.

19. A vibration isolator according to claim 16, wherein
said spring is an elastomer.

20. A vibration isolator for connecting a first body and a second body, comprising:
a housing having a first chamber, a second chamber, and a port connecting said first chamber to said second chamber and permitting fluid to flow between said first chamber and said second chamber, and said first and second chambers and said port defining a fluid reservoir; and
a gas-to-fluid accumulator in fluid communication with said fluid reservoir through first and second passageways, each of said first and second passageways including means for isolating the fluid in said fluid reservoir from said accumulator within the oscillatory pressure range of normal operations.
